(19) United States
(12) Patent Application Publication
(10) Pub. No.: US 2017/0079750 A1
(43) Pub. Date: Mar. 23, 2017

(54) Orthodontic Appliance with Reduced Resistance to Sliding

(71) Applicants: Gary F Blackburn, (US); James Newell Blackburn, (US)

(72) Inventors: James Newell Blackburn, Katy, TX (US); Gary Fife Blackburn, Glendora, CA (US)

(73) Assignees: James Newell Blackburn, Katy, TX (US); Gary F Blackburn, Glendora, CA (US)

(21) Appl. No.: 15/098,152

(22) Filed: Apr. 13, 2016

Related U.S. Application Data
(60) Provisional application No. 62/148,742, filed on Apr. 17, 2015.

(51) Int. Cl. A61C 7/14; A61C 7/16

(52) U.S. Cl. CPC A61C 7/141; A61C 7/16

(57) ABSTRACT

The present invention relates to an improved orthodontic bracket mountable on a tooth surface for use in orthodontic mechanics to facilitate movement of teeth along an arch defined by the shape of an arch wire. This orthodontic bracket appliance of the invention provides reduced resistance to sliding during orthodontic tooth movement by incorporating rotating members within the arch wire channel or tube to reduce friction.

### CROSS REFERENCE TO RELATED APPLICATIONS

This application claims benefit under 35 U.S.C. 119(e) to U.S. provisional patent application Ser. No. 61/148,742, filed Apr. 17, 2015 which is incorporated herein by reference in its entirety.

### FIELD OF THE INVENTION

This invention relates to devices used in the field of orthodontics. More specifically, this invention relates to orthodontic devices or brackets, which are all attached to teeth during orthodontic treatment to allow the movement of teeth by application of forces to the teeth over a period of time. This invention relates to an orthodontic bracket designed to reduce frictional forces between the bracket and the archwire used to guide movement of the teeth relative to one another.

### BACKGROUND OF THE INVENTION

Orthodontic treatment encompasses the correction of dental irregularities and malocclusions by applying controlled precise forces to teeth. The most common form of orthodontic treatment involves the use of orthodontic brackets and wires, which together are commonly referred to as “braces.” Brackets are typically manufactured in specific dimensions, with the most common sizes of brackets having working surfaces (slots) in 0.018×0.025 inch and 0.022×0.025 inch dimensions. Either of these measurements allows for an archwire of similar dimension to be placed in the slot and used to assist in the movement of teeth.

These brackets are typically made of either stainless steel, titanium, plastic composites, or ceramic material. Orthodontic brackets are configured for direct attachment to the patient's teeth or, alternatively, for attachment to bands Which are, in turn, cemented or otherwise secured around the teeth. Once the brackets are affixed to the patient's teeth, such as by means of glue or cement, an archwire is inserted into the slot of each bracket. The archwire acts as a template or track to guide movement of the teeth into proper alignment. In traditional orthodontic brackets, the archwire is secured within the bracket slot by an elastomeric or wire ligature which is wrapped about the tie wings of the bracket. These wings typically extend incisally and gingivally from the base of the bracket.

In order to facilitate the movement of teeth into the correct positions, forces are applied to the bracket and ultimately the tooth via the archwire itself or through orthodontic accessory appliances such as elastomeric bands, springs, or similar appliances. Most orthodontic tooth movements require that the archwire be able to slide freely within the bracket slot. A common problem in orthodontics is known as “force loss” in which the force applied to a tooth is reciprocated by friction between the bracket/archwire interface. This force loss during orthodontic treatment is known as “resistance to sliding”.

Resistance to sliding is commonly divided into three separate categories: friction, binding, and notching. Friction occurs when the archwire and the bracket slot are in contact but are nearly parallel to each other. The frictional forces are generally created through interaction between the bracket, wire and ligature. Means of reducing this friction include coating the slot or archwire with materials known to have reduced coefficients of friction or trading out the traditional ligature system for a passive self-ligating door. These attempts at reducing friction have generally had minimal, yet significant reductions in classical friction.

Though, when the archwire and the bracket slot are not almost perfectly parallel, even by just 2-3 degrees, binding and/or notching become the primary component of resistance to sliding, rather than classical friction. Binding occurs when the archwire is elastically deformed by the bracket slot and notching occurs when the archwire is plastically or permanently deformed by the bracket slot. A significant amount or research has shown that binding and notching account for a huge majority of the resistance to sliding during orthodontic tooth movement. This research also shows that that there is little to no significant difference between current orthodontic bracket systems in reducing binding or notching and ultimately resistance to sliding during orthodontic tooth movement.

There is therefore a need for a new and improved orthodontic bracket which successfully reduces the resistance to sliding during orthodontic tooth movement by reducing not only the friction between the bracket/archwire interface but also by reducing the binding and notching which commonly occurs. It is one non-limiting object of the present invention to provide such an improved orthodontic bracket system.

Heretofore, it has been well known to employ retraction mechanics for moving teeth in the edgewise and straight-wire techniques with brackets having rotatable archwire engaging members that may allow, to an extent, tipping and uprighting, such as disclosed in U.S. Pat. Nos. 4,867,678 and 5,302,121. However, with respect to these bracket appliances, the increased frictional resistance during retraction mechanics extends the time needed to complete the retraction goals, and the time of patient treatment requires heavier forces which may cause root resorption, as well as adversely affecting the comfort of the patient.

Orthodontic brackets are widely used to align teeth through the application of forces selectively provided by interconnected arch wires and accessories.

In edgewise brackets, an archwire passes through a labially opening, horizontal slot defined by one or more pair of opposing tie wings. The archwire is pre-shaped and sized to provide the desired forces. In each bracket, a tie Wing pair includes a gingivally extending tie Wing and occlusally extending tie Wing. Once placed in the slot of one or more pair of tie Wings, an archwire is typically restricted therein by a ligating device such as a steel or elastomeric ligature.

As orthodontic treatment objectives and techniques continue to evolve, numerous corresponding edgewise bracket designs and interconnecting accessories have been proposed.

The innate foundation of edgewise orthodontics is based on the interaction between the archwire and the bracket. In an ideal environment, any force applied to an orthodontic bracket would be perfectly transferred to the tooth. However, several studies have shown that the interaction between the bracket and the archwire are less than ideal due to resistant forces.

Montasser et al. (Montasser et al., 2013) showed that typical force loss due to resistance to sliding during canine retraction with a 0.022″ slot sized bracket on a 0.019×0.025″ is between 35% and 74% of the applied force depending on the type of bracket and archwire material used. Another study by Yanase et al., (Yanase, Ioi, Nishioka, & Takahashi, 2013) found that that the portion of the applied force lost due to resistance to sliding can be greater than 50%. Additionally, Kusy and Whitley (R. P. Kusy & Whitley, 1997) noted that approximately 12% to 60% of applied force in fixed orthodontics is lost to resistance to sliding.

Force loss due to resistance to sliding makes orthodontic treatment unpredictable and requires greater forces than ideal in order to facilitate tooth movement. However, using greater forces increases the risk of undermining bone resorption and root resorption (Matarese et al., 2008). Thus, a thorough understanding of resistance to sliding may be extremely beneficial. Kusy and Whitley (R. P. Kusy & Whitley, 1997) divided resistance to sliding into three separate components: classical friction, elastic binding, and plastic binding or physical notching.

Classical friction occurs when the wire is passively resting in the bracket slot without any angulations and without touching the mesial or distal bracket slot edges. In this instance, the frictional force is equal to the normal force multiplied by the coefficient of friction which is a dimensionless value based on the properties of the two materials in contact (R. P. Kusy, Whitley, & Prewitt, 1991).

Classical friction can be further divided into two components: static and kinetic fiction. Static friction is the force preventing the initial motion between two surfaces. Kinetic friction, which is usually less than static friction, then opposes the direction of motion of the object. Coulomb's third law of friction states that friction is independent of the relative velocity of the sliding motion. However, this law is generally disregarded at low velocities as there is no distinction between static and kinetic friction during orthodontic tooth movement at this force level (Yanase et al., 2013). Furthermore, tooth movement is defined as an intermittent rather than a continuous movement and thus the effects of kinetic friction are minimized (R. P. Kusy & Whitley, 1997).

Binding occurs when the bracket is tipped enough that the archwire comes into contact with the mesial and distal edges of the bracket. The angle at which this contact occurs is known as the critical angle (R. P. Kusy & Whitley, 1999). The critical contact angle can be determined geometrically and is typically about 2.0° for a 0.019×0.025″ archwire and a 0.022″ bracket slot (Thorstenson & Kusy, 2002b). The contact between the bracket edges and the archwire create an interference fit and thus increases the resistance to sliding. As friction increases with the normal force, the binding force increases with the angulation of the bracket (Articolo & Kusy, 1999).

Notching occurs when permanent deformation of the wire occurs at the wire-bracket corner interface. It may be defined as the mechanical damage occurred to the archwire at the latter stages of binding. It creates a sluggish movement and creates obstacles that have the potential to cease sliding altogether (Articolo, Kusy, Saunders, & Kusy, 2000).

As one would expect, the three components of resistance to sliding are not equally contributory to the total resistance. In an extensive review, Burrow (Burrow, 2009) noted that binding makes up the vast majority of resistance to sliding. Articolo and Kusy (Articolo & Kusy, 1999) showed that when a 0.021×0.025″ archwire with a 3° angulation is slid through a 0.022″ bracket slot, binding makes up 73% of the resistance to sliding. When the angle is increased to 7°, binding produces 94% of the resistance to sliding. Furthermore, recent studies showed that such angles of tip should be expected clinically. For example, during sliding mechanics a retracted canine tips an average of 3.4° (Kojima & Fukui, 2005). In another study, it was reported that 7.94° of tipping occurred during canine retraction (Hayashi, Uechi, Murata, & Mizoguchi, 2004).

In the literature, several approaches to means of reduce resistance to sliding have been taken including variations in wire dimensions (Cantarella, Lombardo, & Siciliani, 2013), wire coatings (Farronato et al., 2012 and Farronato, Casiraghi, Gianni, & Salvato, 1988), ligature coatings (De Franco, Spiller Jr, & Von Fraunhofer, 1995), variation in ligature materials (Hain, Dhopatkar, & Rock, 2003), and by far the most popular, self-ligation (Rinchuse & Miles, 2007).

In recent years, significant attention has been placed on self-ligating brackets as a means of decreasing resistance to sliding (Rinchuse & Miles, 2007). Self-ligating brackets replace the common elastomeric ligature, which holds the wire into the slot, with a door that essentially converts the bracket slot into a tube. Passive self-ligation occurs when the door exerts no force on a passively placed bracket whereas active self-ligation occurs when the door exerts a force on a passively placed archwire, thereby pushing it into the slot. Thorstenson and Kusy (Thorstenson & Kusy, 2002a) showed that when a 0.022″ bracket is slid along a “0.019×0.025” archwire with no rotations, angulations or torque, that self-ligating brackets do indeed have lower frictional forces. This is primarily due to the absence of the frictional forces created by an elastomeric ligature. However, when the same brackets were angled at physiological degrees of tip, there were no statistically significant differences between the amounts of resistance to sliding between the self-ligating and conventional bracket systems. This is expected because self-ligating brackets have no effect on binding, which as was noted previously, plays a much larger role than classical friction (Burrow, 2009).

A novel approach to bracket design aimed at reducing not only the friction but also the binding and notching components of sliding mechanics could have significant effects on reducing resistance to sliding. A bracket with reduced resistance to sliding could move teeth more predictably by effectively expressing the forces directly on the teeth involved.

Recently, it has been recognized that it is desirable to reduce frictional engagement between the archwire and bracket surfaces defining the archwire slot to facilitate space closure and bodily tooth movement. Similarly, in many situations, it is now a goal to reduce frictional engagement between the archwire and ligating device employed to restrict the archwire Within the slot. Such friction reduction can markedly increase the rate of tooth movement and reduce the duration of the orthodontic treatment.

### REFERENCES

1. ANDREASEN, G., & JOHNSON, P. (1967). EXPERIMENTAL FINDINGS ON TOOTH MOVEMENTS UNDER TWO CONDITIONS OF APPLIED FORCE. THE ANGLE ORTHODONTIST, 37(1), 9-12.
2. ARTICOLO, L. C., & KUSY, R. P. (1999). INFLUENCE OF ANGULATION ON THE RESISTANCE TO SLIDING IN FIXED APPLIANCES. AMERICAN JOURNAL OF ORTHODONTICS AND DENTOFACIAL ORTHOPEDICS, 115(1), 39-51.
3. ARTICOLO, L. C., KUSY, K., SAUNDERS, C. R., & KUSY, R. P. (2000). INFLUENCE OF CERAMIC AND STAINLESS STEEL BRACKETS ON THE NOTCHING OF ARCHWIRES DURING CLINICAL TREATMENT. EUROPEAN JOURNAL OF ORTHODONTICS, 22(4), 409-425.
4. BURROW, S. J. (2009). FRICTION AND RESISTANCE TO SLIDING IN ORTHODONTICS: A CRITICAL REVIEW. AMERICAN JOURNAL OF ORTHODONTICS AND DENTOFACIAL ORTHOPEDICS, 135(4), 442-447.
5. CANTARELLA, D., LOMBARDO, L., & SICILIANI, G. (2013). THE DYNFORCE ARCHWIRE. ANNALI DI STOMATOLOGIA, 4(2), 204.
6. CASH, A., GOOD, S., CURTIS, R., & MCDONALD, F. (2004). AN EVALUATION OF SLOT SIZE IN ORTHODONTIC BRACKETS-ARE STANDARDS AS EXPECTED? THE ANGLE ORTHODONTIST, 74(4), 450-453.
7. DE FRANCO, D. J., SPILLER JR, R. E., & VON FRAUNHOFER, J. (1995). FRICTIONAL RESISTANCES USING TEFLON-COATED LIGATURES WITH VARIOUS BRACKET-ARCHWIRE COMBINATIONS. THE ANGLE ORTHODONTIST, 65(1), 63-72.
8. FARRONATO, G., CASIRAGHI, G., GIANNI, A., & SALVATO, A. (1988). THE USE OF PTFE IN ORTHODONTICS. MONDO ORTODONTICO, 13(2), 83-89.
9. FARRONATO, G., MAIJER, R., CARÌA, M. P., ESPOSITO, L., ALBERZONI, D., & CACCIATORE, G. (2012). THE EFFECT OF TEFLON COATING ON THE RESISTANCE TO SLIDING OF ORTHODONTIC ARCHWIRES. THE EUROPEAN JOURNAL OF ORTHODONTICS, 34(4), 410-417.
10. HAIN, M., DHOPATKAR, A., & ROCK, P. (2003). THE EFFECT OF LIGATION METHOD ON FRICTION IN SLIDING MECHANICS. AMERICAN JOURNAL OF ORTHODONTICS AND DENTOFACIAL ORTHOPEDICS, 123(4), 416-422.
11. HAMDAN, A., & ROCK, P. (2008). THE EFFECT OF DIFFERENT COMBINATIONS OF TIP AND TORQUE ON ARCHWIRE/BRACKET FRICTION. EUROPEAN JOURNAL OF ORTHODONTICS, 30(5), 508-514. DOI:10.1093/EJO/CJN017 [DOI]
12. HAYASHI, K., UECHI, J., MURATA, M., & MIZOGUCHI, I. (2004). COMPARISON OF MAXILLARY CANINE RETRACTION WITH SLIDING MECHANICS AND A RETRACTION SPRING: A THREE-DIMENSIONAL ANALYSIS BASED ON A MIDPALATAL ORTHODONTIC IMPLANT. THE EUROPEAN JOURNAL OF ORTHODONTICS, 26(6), 585-589.
13. JOCH, A., PICHELMAYER, M., & WEILAND, F. (2010). BRACKET SLOT AND ARCHWIRE DIMENSIONS: MANUFACTURING PRECISION AND THIRD ORDER CLEARANCE. JOURNAL OF ORTHODONTICS, 37(4), 241-249.
14. KAPILA, S., ANGOLKAR, P. V., DUNCANSON JR, M. G., & NANDA, R. S. (1990). EVALUATION OF FRICTION BETWEEN EDGEWISE STAINLESS STEEL BRACKETS AND ORTHODONTIC WIRES OF FOUR ALLOYS. AMERICAN JOURNAL OF ORTHODONTICS AND DENTOFACIAL ORTHOPEDICS, 98(2), 117-126.
15. KIM, K., CHUNG, C., CHOY, K., LEE, J., & VANARSDALL, R. L. (2005). EFFECTS OF PRESTRETCHING ON FORCE DEGRADATION OF SYNTHETIC ELASTOMERIC CHAINS. AMERICAN JOURNAL OF ORTHODONTICS AND DENTOFACIAL ORTHOPEDICS, 128(4), 477-482.
16. KOJIMA, Y., & FUKUI, H. (2005). NUMERICAL SIMULATION OF CANINE RETRACTION BY SLIDING MECHANICS. AMERICAN JOURNAL OF ORTHODONTICS AND DENTOFACIAL ORTHOPEDICS, 127(5), 542-551.
17. KRISHNAN, M., KALATHIL, S., & ABRAHAM, K. M. (2009). COMPARATIVE EVALUATION OF FRICTIONAL FORCES IN ACTIVE AND PASSIVE SELF-LIGATING BRACKETS WITH VARIOUS ARCHWIRE ALLOYS. AMERICAN JOURNAL OF ORTHODONTICS AND DENTOFACIAL ORTHOPEDICS, 136(5), 675-682.
18. KUSY, R. P., & WHITLEY, J. Q. (1997). FRICTION BETWEEN DIFFERENT WIRE-BRACKET CONFIGURATIONS AND MATERIALS. PAPER PRESENTED AT THE SEMINARS IN ORTHODONTICS, 3(3) 166-177.
19. KUSY, R. P., & WHITLEY, J. Q. (1999). INFLUENCE OF ARCHWIRE AND BRACKET DIMENSIONS ON SLIDING MECHANICS: DERIVATIONS AND DETERMINATIONS OF THE CRITICAL CONTACT ANGLES FOR BINDING. THE EUROPEAN JOURNAL OF ORTHODONTICS, 21(2), 199-208.
20. KUSY, R. P., WHITLEY, J. Q., & PREWITT, M. J. (1991). COMPARISON OF THE FRICTIONAL COEFFICIENTS FOR SELECTED ARCHWIRE-BRACKET SLOT COMBINATIONS IN THE DRY AND WET STATES. THE ANGLE ORTHODONTIST, 61(4), 293-302.
21. KUSY, R., & WHITLEY, J. (1989). EFFECTS OF SLIDING VELOCITY ON THE COEFFICIENTS OF FRICTION IN A MODEL ORTHODONTIC SYSTEM. DENTAL MATERIALS, 5(4), 235-240.
22. LEE, C., & HWANG, S. M. (2015). A COMPARATIVE STUDY OF FRICTIONAL FORCE IN SELF-LIGATING BRACKETS ACCORDING TO THE BRACKET-ARCHWIRE ANGULATION, BRACKET MATERIAL, AND WIRE TYPE. THE KOREAN JOURNAL OF ORTHODONTICS, 45(1), 13-19.
23. MATARESE, G., NUCERA, R., MILITI, A., MAZZA, M., PORTELLI, M., FESTA, F., & CORDASCO, G. (2008). EVALUATION OF FRICTIONAL FORCES DURING DENTAL ALIGNMENT: AN EXPERIMENTAL MODEL WITH 3 NONLEVELED BRACKETS. AMERICAN JOURNAL OF ORTHODONTICS AND DENTOFACIAL ORTHOPEDICS, 133(5), 708-715.
24. MONTASSER, M. A., EL-BIALY, T., KEILIG, L., REIMANN, S., JAGER, A., & BOURAUEL, C. (2013). FORCE LOSS IN ARCHWIRE-GUIDED TOOTH MOVEMENT OF CONVENTIONAL AND SELF-LIGATING BRACKETS. THE EUROPEAN JOURNAL OF ORTHODONTICS,
25. QUINN, R. S., & YOSHIKAWA, D. K. (1985). A REASSESSMENT OF FORCE MAGNITUDE IN ORTHODONTICS. AMERICAN JOURNAL OF ORTHODONTICS, 88(3), 252-260.
26. REDLICH, M., KATZ, A., RAPOPORT, L., WAGNER, H., FELDMAN, Y., & TENNE, R. (2008). IMPROVED ORTHODONTIC STAINLESS STEEL WIRES COATED WITH INORGANIC FULLERENE-LIKE NANOPARTICLES OF WS 2 IMPREGNATED IN ELECTROLESS NICKEL-PHOSPHOROUS FILM. DENTAL MATERIALS, 24(12), 1640-1646.
27. RINCHUSE, D. J., & MILES, P. G. (2007). SELF-LIGATING BRACKETS: PRESENT AND FUTURE. AMERICAN JOURNAL OF ORTHODONTICS AND DENTOFACIAL ORTHOPEDICS, 132(2), 216-222.
28. STEFANOS, S., SECCHI, A. G., COBY, G., TANNA, N., & MANTE, F. K. (2010). FRICTION BETWEEN VARIOUS SELF-LIGATING BRACKETS AND ARCHWIRE COUPLES DURING SLIDING MECHANICS. AMERICAN JOURNAL OF ORTHODONTICS AND DENTOFACIAL ORTHOPEDICS, 138(4), 463-467.
29. STOREY, E., & SMITH, R. (1952). FORCE IN ORTHODONTICS AND ITS RELATION TO TOOTH MOVEMENT. AUST J DENT, 56(1), 11-18.
30. THOMAS, S., SHERRIFF, M., & BIRNIE, D. (1998). A COMPARATIVE IN VITRO STUDY OF THE FRICTIONAL CHARACTERISTICS OF TWO TYPES OF SELF-LIGATING BRACKETS AND TWO TYPES OF PRE-ADJUSTED EDGEWISE BRACKETS TIED WITH ELASTOMERIC LIGATURES. EUROPEAN JOURNAL OF ORTHODONTICS, 20(5), 589-596.
31. THORSTENSON, G. A., & KUSY, R. P. (2002A). COMPARISON OF RESISTANCE TO SLIDING BETWEEN DIFFERENT SELF-LIGATING BRACKETS WITH SECOND-ORDER ANGULATION IN THE DRY AND SALIVA STATES. AMERICAN JOURNAL OF ORTHODONTICS AND DENTOFACIAL ORTHOPEDICS, 121(5), 472-482.
32. THORSTENSON, G. A., & KUSY, R. P. (2002B). EFFECT OF ARCHWIRE SIZE AND MATERIAL ON THE RESISTANCE TO SLIDING OF SELF-LIGATING BRACKETS WITH SECOND-ORDER ANGULATION IN THE DRY STATE. AMERICAN JOURNAL OF ORTHODONTICS AND DENTOFACIAL ORTHOPEDICS, 122(3), 295-305.
33. YANASE, Y., 101, H., NISHIOKA, M., & TAKAHASHI, I. (2013). EFFECTS OF SLIDING VELOCITY ON FRICTION: AN IN VITRO STUDY AT EXTREMELY LOW SLIDING VELOCITY APPROXIMATING ORTHODONTIC TOOTH MOVEMENT. THE ANGLE ORTHODONTIST, 84(3), 451-458.

### SUMMARY OF THE INVENTION

To solve the problems described above, an object of the present invention is to provide an orthodontic bracket which allows the archwire to move more freely within the archwire slot and can thereby minimize the above mentioned resistance to sliding. The embodiment of the present invention includes an orthodontic bracket comprised of a base and an archwire receiving member known as a bracket slot. The surfaces at the incisal/occlusal and gingival aspects of the bracket slot are known as the bracket slot “walls”. The surface at the base of the bracket slot is known as the bracket slot “floor”. The bracket slot floor lies perpendicular to the bracket slot walls. Extending from the bracket slot are four wings which serve to secure a ligature to the orthodontic bracket. The bracket has four holes manufactured through the base of the bracket and extending parallel to the four corners of the bracket slot. A rod comprised of either metal, ceramic, or plastic, which may be coated with a substance such as polytetrafluoroethylene is inserted into the holes. The holes and the walls of the slot are formed in such a way as to not violate the integrity of the bracket slot dimensions. Thus, as an archwire is inserted into the bracket slot, the archwire will not contact the walls or edges of the bracket slot but solely the floor of the bracket slot, the rotating rods, and the securing ligature. Thereby, the archwire is able to roll along the rods during orthodontic tooth movement with reduced friction and without binding or notching at the edges of the bracket slot.

Another embodiment of the present invention is related to an orthodontic bracket that comprises a base and an archwire receiving member known as a bracket slot. In addition to the holes and rods included in the previously mentioned embodiment of the invention, the bracket slot would include holes which are parallel to the bracket slot floor, and similar rods be inserted into those holes. Thus, when an archwire is inserted into the bracket slot, the archwire would contact the rotating rods, and the securing ligature, thus further reducing any contact between the archwire and the bracket base itself.

Another embodiment of the present invention is related to an orthodontic bracket that comprises a base and an and an archwire receiving member known as a bracket slot. In addition to the holes and rods included in the previously mentioned embodiments of the invention, the bracket slot would include a self-ligating door which, in essence, would create a ceiling for the bracket slot, which may or may not include holes drilled parallel to the ceiling. Similar rods as mentioned in the previous embodiments can be inserted into those holes. Thus, when an archwire is inserted into the bracket slot, the archwire would contact solely the rotating rods, thus further reducing any contact between the archwire and the bracket base itself.

The invention is also directed toward an orthodontic bracket that comprises a base and an and an archwire receiving member known as a bracket slot. In addition to the rotating members within the archwire slot, the bracket base is attached to a band which is intended to wrap around the tooth. The band then may be glued or cemented in place.

The invention is also directed toward an orthodontic bracket that comprises a base and an and an archwire receiving member known as a bracket slot. In addition to the rotating members within the archwire slot, the bracket base is attached to a band which is intended to wrap around the tooth. The band then may be glued or cemented in place.

The invention is also directed toward an orthodontic bracket that comprises a base and an and an archwire receiving member known as a bracket slot. In addition to the holes and rods included in the previously mentioned embodiments of the invention, the bracket slot would include a surface at the facial aspect of the slot and thereby creating a bracket slot ceiling and converting the bracket slot into a tube. The bracket tube may or may not include holes drilled parallel to the ceiling. Similar rods as mentioned in the previous embodiments can be inserted into those holes. Thus, when an archwire is inserted into the bracket slot, the archwire would contact solely the rotating rods, thus further reducing any contact between the archwire and the bracket base itself.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings

FIG. 1 is an exploded view of one embodiment of the bracket of the invention.

FIG. 2 is the bracket of FIG. 1 in its non-exploded configuration.

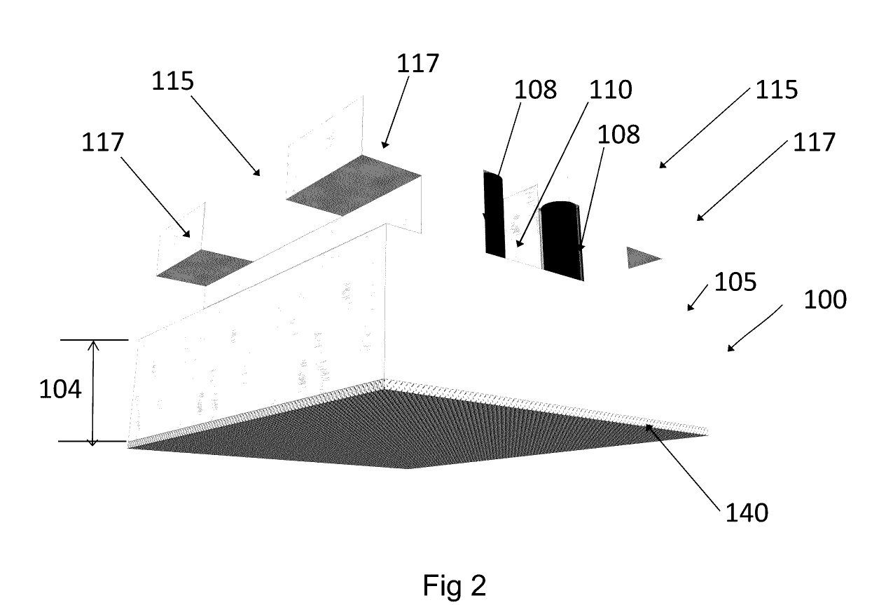

FIG. 3 is a perspective view of an orthodontic bracket with holes through the base parallel to the walls of the bracket slot according to one embodiment of the invention.

FIG. 4 is a perspective view of the orthodontic bracket shown in FIG. 3 with rods inserted into the holes;

FIG. 5 is a view showing the bottom of the orthodontic bracket in FIG. 4.

FIG. 6 is a perspective top view of the orthodontic bracket with rods shown in FIG. 1 with an archwire inserted into the bracket slot;

FIG. 7 is a perspective view illustrating a different embodiment of the invention wherein a bracket is constructed similarly to the orthodontic bracket in FIG. 1 but with holes and rods parallel to the floor of the bracket.

FIG. 8 is a perspective view illustrating a bracket constructed similarly to the orthodontic bracket in FIG. 1 but with the bracket slot covered with a ceiling in accordance with another embodiment of the invention.

FIG. 9 shows the dependence of the resistance to sliding on the degree of tip of the bracket (bracket angulation) for the combined data from the four bracket types tested.

FIG. 10 is a chart showing a comparison of the bracket of the invention (“Novel Bracket”) to the 3M bracket with regard to resistance to sliding.

### DETAILED DESCRIPTION OF THE INVENTION

The present invention is directed to an orthodontic bracket including a bracket base, at least one archwire slot formed in the base adapted to receive and archwire therein, and means for incorporating rotating members into the walls, corners, floor or ceiling of the archwire slot so as to allow for reduced binding and friction as an archwire slides within the archwire slot. The archwire slot is defined by sidewalls disposed on either side of the slot.

In one embodiment of the invention, the bracket consists of a base plate having a top surface and a bottom surface. The bottom surface of the base plate is generally used to adhere the bracket to the teeth of the patient. On the top surface of the base plate are at least two elongated rectilinear members arranged to form a channel therebetween, the members and base plate adapted to receive an archwire. In use, brackets are placed on several of the patient's teeth, each bracket adapted to receive the archwire. The bracket is adapted to allow the archwire to be movably retained with in the channel such that the teeth can move along the path defined by the archwire the brackets are generally further adapted to allow retaining elements to be attached to the bracket, for example, elastic bands. The present invention provides an improved orthodontic bracket which comprises movable rollers with in the archwire channel to allow movement of the bracket relative to the archwire with reduced friction.

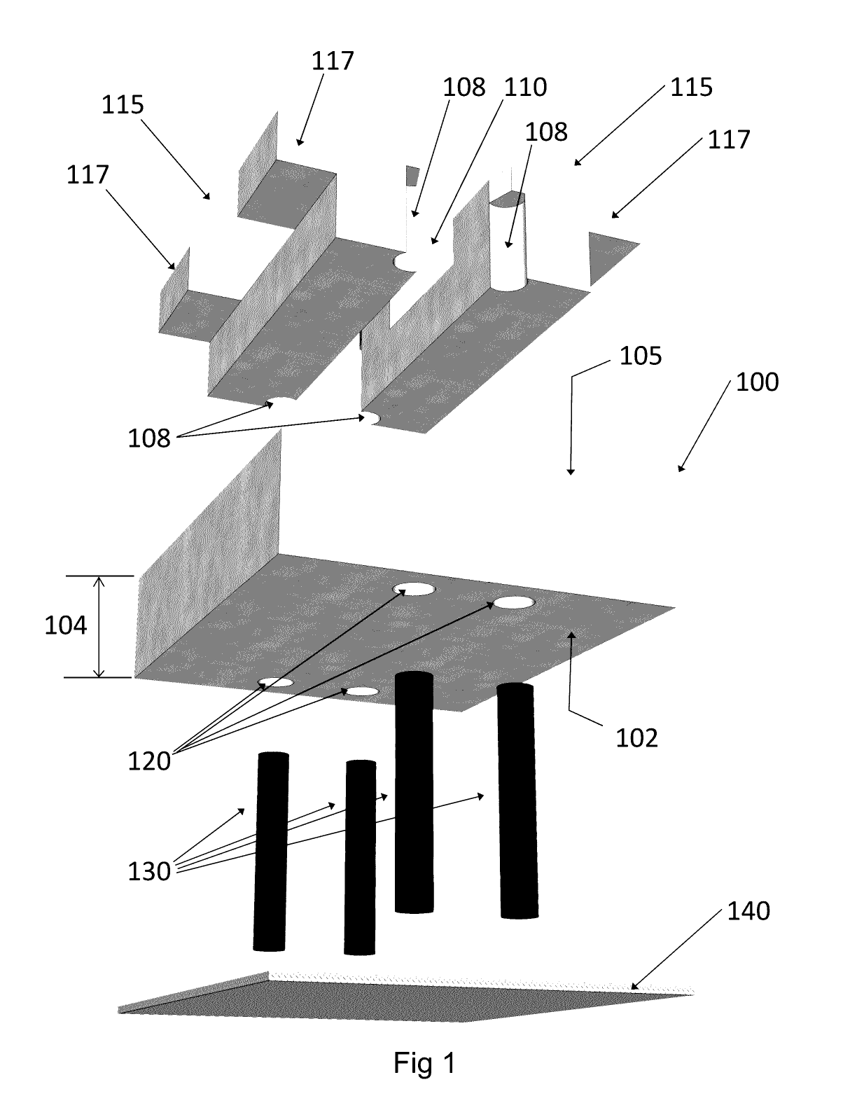

In a preferred embodiment of the invention the bracket is a monolithic device fabricated from metal. To aid the description of the bracket, the bracket will be described as if it were composed of separate components, although the bracket is preferably a monolithic device. The structure of the monolithic bracket consists of a base plate having two surfaces as shown in FIG. 1. The bottom surface 102 is used for attachment to the tooth, and the top surface 105 is adapted to define an archwire channel 110 defined by two elongated channel wall members 115 formed on the top surface of the base plate 100. The base plate contains four or more circular holes 120 passing through the base plate from the top surface to the bottom surface. The holes in the base plate are adapted to receive rollers 130 which are generally cylindrical in shape and have a length which is greater than the thickness 104 of the base plate. The rollers thus protrude above the top surface of the base plate. The elongated channel wall members which, together with the top surface of the base plate, define the archwire channel. The elongated channel wall members contain recesses 108, which may be rectangular, square, semicircular or quarter-circular in cross section, and are adapted to receive the protruding end of the rollers. The geometric arrangement of the holes, the elongated channel wall members, and the rollers is such so as to form a sliding channel for the archwire which is slightly narrower than the channel defined by the channel wall members themselves. The holes in the base plate and the recesses in the channel wall members are dimensioned so as to support and retain the rollers while allowing the rollers to rotate around their longitudinal axis. In practice, the archwire will generally be slightly narrower than the width of the sliding channel defined by the rollers of the bracket apparatus. The apparatus of the invention thereby forms an orthodontic bracket which will allow [the movement of the bracket and the archwire relative to one another with reduced friction allowed by the movement of the rollers around their longitudinal axes.

In another embodiment of the invention, the elongated wall channel members further contain protrusions 117 which are adapted to retain elastic bands used in the orthodontic process. In practice, the elastic bands are retained by protrusions on one elongated channel wall member and by protrusions on the second channel wall member, thereby retaining the archwire with in the sliding channel.

In a further embodiment of the invention, the bracket is adapted to comprise a hinged top plate to retain the archwire within the sliding channel. The top plate is in hingeably attached to one of the channel wall members and/or the base plate so as to allow the top plate to be closed over the sliding channel following insertion of the archwire into the bracket's sliding channel. Once closed, the top plate forms an upper surface for the sliding channel. Generally, the bracket of this embodiment will further comprise a mechanism to latch the top plate in its closed position. Such top plates hingeably attached to orthodontic brackets are known to those skilled in the art, as are latching mechanisms to retain the hinged top plate in its closed position. Brackets of the present invention comprising the hinged top plate do not require elastic bands to retain the archwire within the sliding channel.

In another embodiment of the invention, the orthodontic bracket may further comprise an attachment plate 140 beneath and attached to the bottom surface of the base plate. The attachment plate is adapted, to provide improved adhesion to the patient's tooth. The attachment plate may be adapted with physical protrusions, surface roughness features, and/or chemical surface modification to allow improved adhesion to the tooth using and adhesive material. Advantageously, the attachment plate will further aid in retaining the rollers in their proper position by closing the bottom end of the holes in the baseplate.

In a further embodiment of the invention the rollers may be comprised of solid metal, hollow tubes of metal, or of solid rigid plastic. Examples of solid rigid plastic include polycarbonate, nylon, polyester, ABS, poly methyl methacrylate, and, composite plastic materials.

In yet another embodiment of the invention, the surfaces of the rollers may be coated with a thin layer of a low friction material. Examples of such low friction materials which may be employed in the invention include Teflon®, fluorinated polymers, parylene, and polyimide.

In a further embodiment of the invention, the bracket may comprise greater than four rollers, with their associated holes in the baseplate and recesses in the channel wall members.

The orthodontic brackets of the present invention are manufactured by any of several techniques known in the art for fabricating small metal or plastic devices. For example, brackets are fabricated using an automated CNC mill. The holes in the bracket are drilled in a separate process into the bottom of the bracket material block prior to machining of the remainder of the bracket. Once drilled, the bracket material block is positioned in the CNC mill and the remaining features are machined from the bracket material block.

The rollers of the bracket may be machined from metal rod or metal tubing. Such metal rod and metal tubing can be purchased commercially and can be purchased with friction reducing materials on the rod or tubing surfaces.

The brackets of the present invention can also be fabricated using 3-D printing techniques as are well known in the art. The brackets are designed, drawn, and defined dimensionally using computer aided drafting (CAD) software. Electronic files containing the bracket design are transferred to the 3-D printing machine. The 3-D printer then, builds the bracket by printing thin layers of polymer, or metal, one on top of another. The dimensions of each layer of the material are altered so as to create a three-dimensional object, one layer at a time. The bracket of the present invention is printed using a three-dimensional printer having the ability to print two different materials. The material of the bracket is printed layer by layer along with non-bracket material such that all voids in each layer are filled with non-bracket material. Each layer, thus has a planar surface upon which the next layers may be deposited. Overhanging protrusions of the bracket material can thus be printed on top of non-bracket material which provides support for the bracket material during manufacture. The two-material 3-D printing is used to print the brackets of the present invention where in the recesses in the channel wall members are enclosed at the top of the recess. During 3-D printing, the non-bracket material fills the recess area of each layer. The top layer of the non-bracket material thus supports the first layer off the top of the recess area printed with the bracket material. Following printing, the completed bracket is separated from the non-bracket material.

The rollers are cut to length from longer rods or tubing using machining techniques familiar to those skilled in the art. The rollers are inserted into the holes of the bracket from the bottom. The optional adhesion plate may then be attached to the bottom of the bracket, conveniently retaining the rollers within the bracket structure, yet free to rotate about their longitudinal axis.

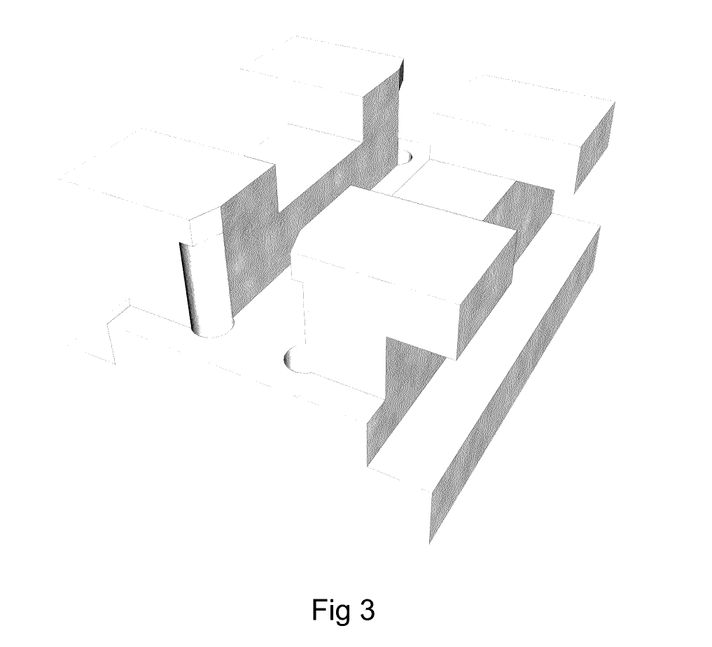

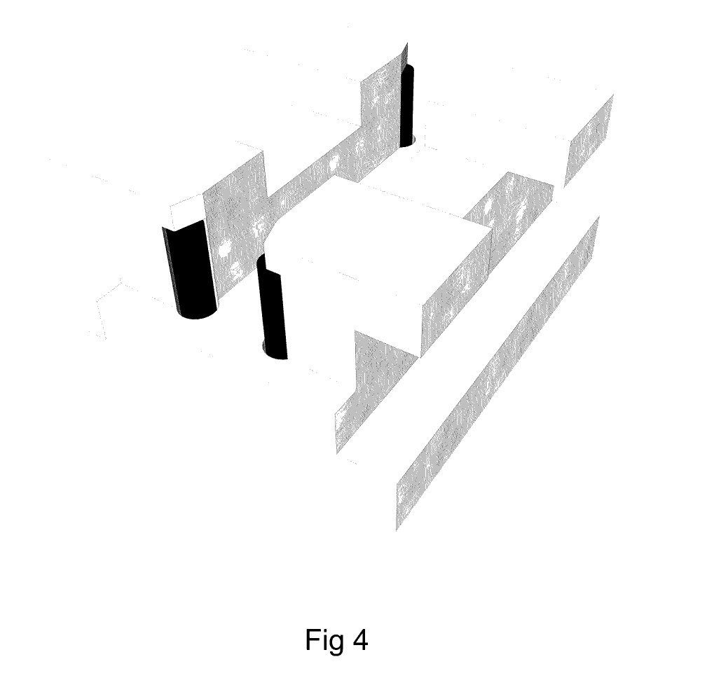

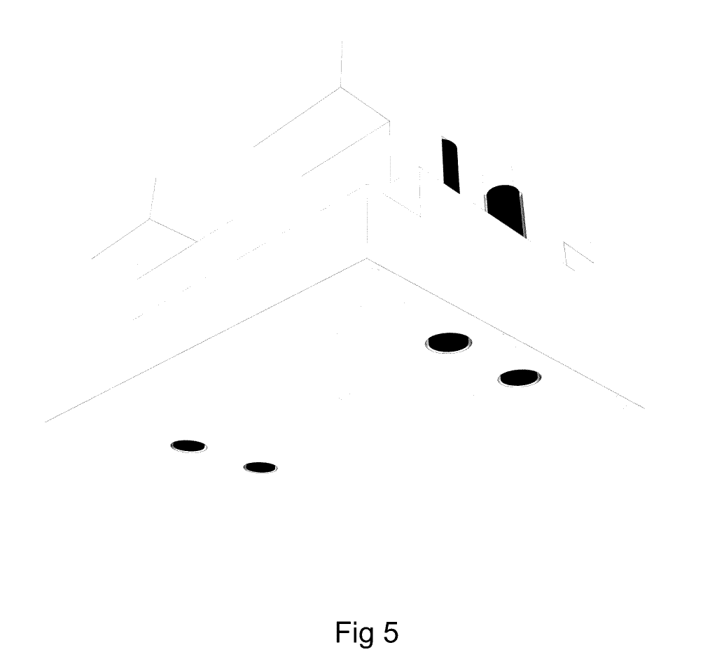

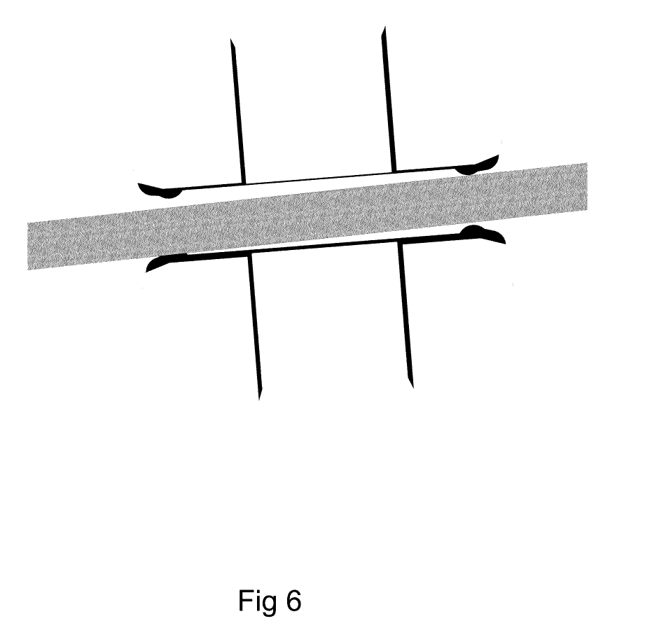

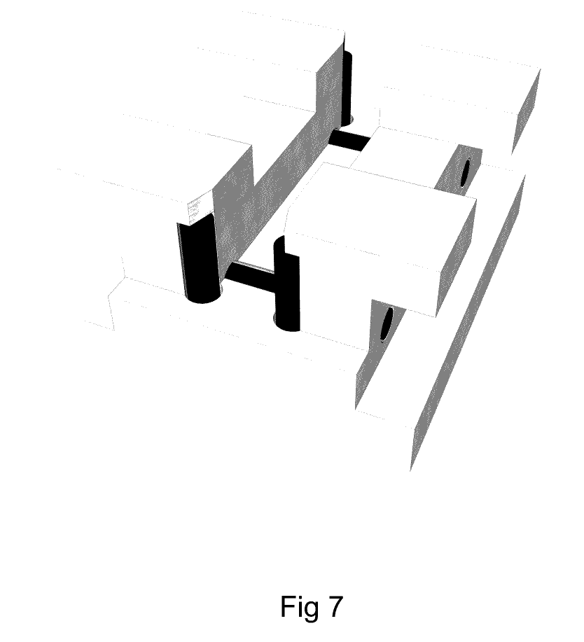

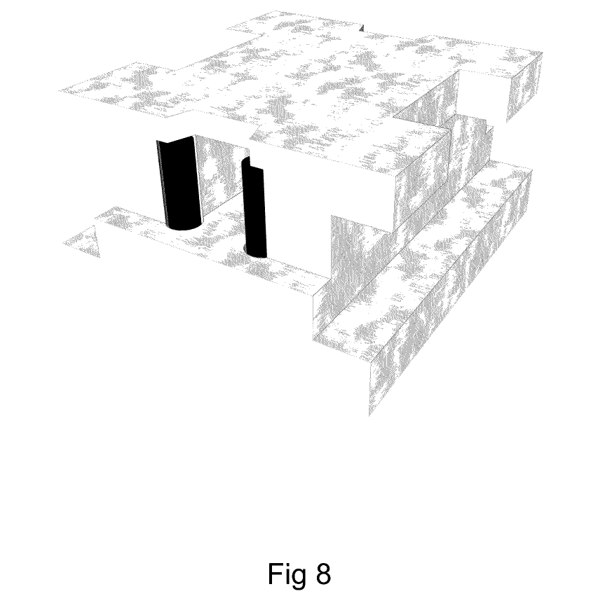

FIGS. 3 through 8 show various embodiments of the bracket of the invention. FIG. 7 shows one preferred embodiment of the bracket where the bracket comprises six rollers. The two additional rollers are in the floor of the archwire slot to further reduce friction of the archwire to the bracket.

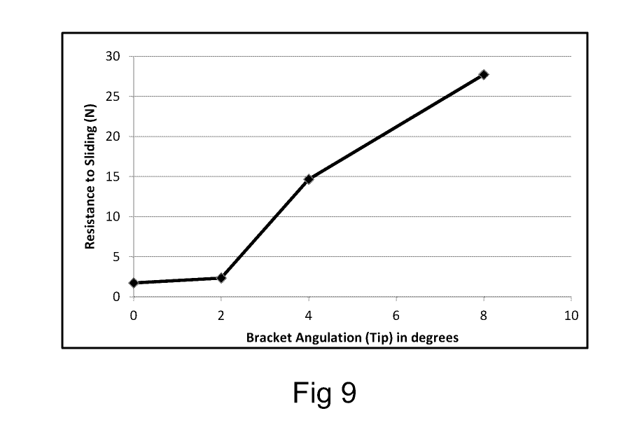

FIG. 9 shows an additional embodiment of the invention where the archwire slot is covered by a ceiling plate to help keep the archwire in the archwire channel.

In one embodiment of the invention, the orthodontic device comprises a baseplate having a top surface and a bottom surface; two at least approximately rectilinear elongated channel wall members having a width, W, a height, H, and a depth, D, wherein one face of each of said members, defined by dimensions W and D (face WD) is attached to the top surface of the baseplate; and wherein said members are each attached to said baseplate such that a separate face of each of the two members, defined by the dimensions W and D (face WD), face one another and are at least approximately parallel and spaced apart by a distance, M, so as to form a channel therebetween, said channel being defined by a portion of the top surface of said baseplate and by the two faces defined by the dimensions H and D of said elongated members (face HD), such that said channel has a volume approximately equal to D×H×M and such that the channel has a first end and a second end and a top, each of which is not enclosed; and four at least approximately cylindrical rollers, each having a longitudinal axis through the center point of the two at least approximately circular faces of said cylindrical rollers; wherein each of said cylindrical rollers is positioned at least partially within said channel and each is placed such that its longitudinal axis is at least approximately perpendicular to said top face of said baseplate; and wherein two of said cylindrical rollers are each positioned partially within first and second recesses in said face HD of one of said channel wall members, the first said recess approximate at the first end of said channel and the other recess approximately at the second end of said channel; and wherein the other two of said cylindrical rollers are each positioned partially within third and fourth recesses in said face HD of the other said channel wall member, the third said recess approximate at the first end of said channel and the fourth recess approximately at the second end of said channel; and wherein the two said cylindrical rollers approximately at the first end of said channel are separated by a distance, N1, and the other two said cylindrical rollers at the second end of said channel are separated by a distance, N2, where N1 and N2 are each less than said distance M and may be equal or not equal; and wherein one end of each of said cylindrical rollers is positioned in a respective hole in said baseplate; and wherein the other end of each of said cylindrical rollers is positioned partially within said recesses in said face HD of said channel wall members; and wherein said holes and said recesses have dimensions to provide support for said cylindrical rollers to at least approximately maintain the position of said cylindrical rollers while allowing said cylindrical rollers to rotate about their respective longitudinal axes.

In another embodiment, the orthodontic device further comprises an adhesion pad attached to the bottom face of said base plate.

In still another embodiment of the orthodontic device said holes in said baseplate extend from the top surface of the baseplate to the bottom face of the baseplate.

In one preferred embodiment of said orthodontic device, said holes are approximately cylindrical or square in cross-section.

In a particularly preferred embodiment of the orthodontic device, said recesses are approximately circular in cross section or are approximately rectangular in cross section.

In other preferred embodiments of the orthodontic device, the cylinders are hollow tubes or are solid, or are coated with a low friction material such as Teflon, parylene, or a fluoropolymer.

In other preferred embodiments of the orthodontic device, the baseplate, elongated members, and cylindrical rollers are composed of metal, most preferably stainless steel or titanium.

In another embodiment, the baseplate, elongated members, and cylindrical rollers are independently composed ceramic material.

In a preferred embodiment of the orthodontic device, the dimensions L, H, D, M, and N are each less than 5 millimeters.

In a more preferred embodiment of the orthodontic device, the dimensions L, H, D, M, and N are each less than 3 millimeters.

In a particularly preferred embodiment of the orthodontic device, the dimensions L, H, D, M, and N are each less than 2 millimeters.

In yet another embodiment of the orthodontic device, the device further comprises an arch wire retained in said sliding channel.

In a more preferred embodiment of the orthodontic device, the arch wire has a circular cross section or a rectangular cross section, or an oval cross section.

In a preferred embodiment of the orthodontic device, the orthodontic device comprises a metal bracket comprising at least one cylindrical roller at least partially defining a sliding channel for an arch wire, wherein said cylindrical roller is retained in position by said metal bracket and is free to rotate about its longitudinal axis.

The invention herein described also includes a method for adjusting the position of teeth in a person, where the method comprises attaching one or more of the orthodontic devices described herein in any of the embodiments described, to one or more teeth of the person, said orthodontic device comprises a baseplate having a top surface and a bottom surface; two at least approximately rectilinear elongated channel wall members having a width, W, a height, H, and a depth, D, wherein one face of each of said members, defined by dimensions W and D (face WD) is attached to the top surface of the baseplate; and wherein said members are each attached to said baseplate such that a separate face of each of the two members, defined by the dimensions W and D (face WD), face one another and are at least approximately parallel and spaced apart by a distance, M, so as to form a channel therebetween, said channel being defined by a portion of the top surface of said baseplate and by the two faces defined by the dimensions H and D of said elongated members (face HD), such that said channel has a volume approximately equal to D×H×M and such that the channel has a first end and a second end and a top, each of which is not enclosed; and four at least approximately cylindrical rollers, each having a longitudinal axis through the center point of the two at least approximately circular faces of said cylindrical rollers; wherein each of said cylindrical rollers is positioned at least partially within said channel and each is placed such that its longitudinal axis is at least approximately perpendicular to said top face of said baseplate; and wherein two of said cylindrical rollers are each positioned partially within first and second recesses in said face HD of one of said channel wall members, the first said recess approximate at the first end of said channel and the other recess approximately at the second end of said channel; and wherein the other two of said cylindrical rollers are each positioned partially within third and fourth recesses in said face HD of the other said channel wall member, the third said recess approximate at the first end of said channel and the fourth recess approximately at the second end of said channel; and wherein the two said cylindrical rollers approximately at the first end of said channel are separated by a distance, N1, and the other two said cylindrical rollers at the second end of said channel are separated by a distance, N2, where N1 and N2 are each less than said distance M and may be equal or not equal; and wherein one end of each of said cylindrical rollers is positioned in a respective hole in said baseplate; and wherein the other end of each of said cylindrical rollers is positioned partially within said recesses in said face HD of said channel wall members; and wherein said holes and said recesses have dimensions to provide support for said cylindrical rollers to at least approximately maintain the position of said cylindrical rollers while allowing said cylindrical rollers to rotate about their respective longitudinal axes, and affixing an arch wire to said one or more orthodontic devices within said channel of each orthodontic device such that said orthodontic devices attached to said teeth are able to slide longitudinally along said arch wire.

In another preferred method, comprising a method for adjusting the position of teeth in a person, the method comprises attaching one or more orthodontic devices to one or more teeth of the person, said orthodontic device comprises a metal bracket comprising at least one cylindrical roller at least partially defining a sliding channel for an arch wire, wherein said cylindrical roller is retained in position by said metal bracket and is free to rotate about its longitudinal axis, and affixing an arch wire to said one or more orthodontic devices such that said orthodontic devices attached to said teeth are able to slide longitudinally along said arch wire.

### Example 1

### Bracket Fabrication and Testing in Comparison to Commercial Brackets

### Materials and Methods

Four types of brackets (n=10, each) were tested in this study: a conventional bracket, the Victory Series™ Low Profile bracket (3M Unitek, Monrovia, Calif.), a passive self-ligating bracket, the Damon Q bracket (Ormco Corp, Orange, Calif.), an active self-ligating bracket, the In-Ovation R bracket (Dentsply GAC, Bohemia, N.Y.), and the bracket of the invention as depicted in FIG. 1.

The bracket of the invention was manufactured by Micro Precision Parts Manufacturing Ltd. (Qualicum Beach, BC) via CNC-milling technique. The bracket was fitted with polytetrafluoroethylene (PTFE of Teflon) coated stainless steel rollers (Amazon Supply, Seattle, Wash.) positioned precisely at the four corners of the bracket slot (FIG. 1). The walls of the slot were recessed to prevent any contact with an inserted archwire though the rollers were positioned in such a way as to maintain the integrity of the slot dimensions and the pins were hand inserted and individually observed under a microscope to ensure movement of the Teflon roller pins was not inhibited. The Teflon pins were expected to reduce the frictional forces between the bracket and the rolling of the pins with the potential of reducing the overall binding and notching that comprises the majority of resistance to sliding.

All four bracket types had 0.22″ slot widths and were made of stainless steel. The prescription differences of the brackets were non-consequential as all prescribed bracket angulations were compensated for during testing by the design of the testing jig.

The testing jig used in a previous study by Hamdan and Rock (Hamdan & Rock, 2008, European Journal of Orthodontics, 30(5), 508-514) was utilized in the present investigation by following the same protocol. The jig was custom made so that it could be clamped to a mechanical testing machine (MTS Insight 30 MTS, Eden Prairie, Minn.) and could be manipulated so that tip in 1° increments could be produced at the bracket slot of an upper canine bracket.

The jig was comprised of two parts. One part, which was firmly mounted to the jig baseplate, was designed to hold a straight wire with variable tension. The length of the test wire was set at 18.4 mm to represent the clinical wire span present during a premolar extraction case and all wires were subjected to a 300 g tensile force as recommended by Kapila et al. (Kapila, Angolkar, Duncanson Jr, & Nanda, 1990, American Journal of Orthodontics and Dentofacial Orthopedics, 98(2), 117-126).

The other half of the jig was designed to hold the bracket mounted to a stainless steel slug at varying degrees of tip. This part of the jig was hinged which allowed the mounted bracket to be brought to the mounted wire and ligated together (Figure . . . ).

In the present study, a 0.021×0.025″ calibration wire was inserted into the jig and tensed to 300 g as measured by the MTS Insight 30. A bracket was then ligated to the wire and a blank mounting rod was inserted into the jig. The large sized wire was used to ensure correct alignment and the removal of all tip and torque. The jig was set to 0° of tip and Transbond XT (3M Unitek, Monrovia, Calif.) light cure adhesive paste was placed on the base of the bracket and the end of the mounting rod. The hinged rod was brought to the vertical so that the composite on the mounting stub united with the composite on the base of the bracket. The bracket was positioned to lie in the center of the mounting rod and the composite was then cured by light activation for 20 seconds on either side of the bracket using a curing light. Forty brackets (n=10 each, for 4 groups) were mounted in one session on the same 0.021×0.025″ wire to avoid any variation between mountings.

Once the 0.019×0.025″ archwire was placed into the jig, cinched into place and tensed to 300 g, one of the previously calibrated brackets was then inserted and tightened into the opposing part of the jig. The hinged rod was then brought to the vertical, bringing the bracket against the wire so that it could be ligated.

A loop of 0.032″ round stainless steel wire, clamped to the upper crosshead of the MTS Insight 30 testing machine was positioned under the bracket tie wings. With the bracket positioned at the bottom of the test wire, the loop was raised until it just touched the bracket so that a reading registered on the MTS Insight 30 dial. The bracket was then moved up by 3.7 mm to represent the distance between the distal edge of an upper second premolar bracket and the mesial edge of a first molar tube. Tip and torque values were then set and the MTS Insight 30 recalibrated to zero to account for the weight of the slide assembly. The initial force peak as well as the maximum and minimum forces was recorded over a wire span of 7 mm at a speed of 10 mm/min.

Each bracket was tested at 0°, 2°, 4°, 6°, and 8° of tip and the 0.019×0.025″ wire was replaced following each test to account for any wire bending or fatigue during the testing. The bracket testing order and the five different degrees of tip for each bracket was randomized during the experiment.

The resistance to sliding was measured in Newtons (N) for each experimental condition and the results were analyzed using one-way analysis of variance (ANOVA) in the SPSS statistical program (SPSS, Chicago, Ill.). Post-hoc Students T-test was performed following positive ANOVA tests to identify significance between groups. The level of significance for all the tests was set at P<0.05.

### Results

When the apparatus was tested with a mounted bracket but no archwire, the system consistently demonstrated a resistance to sliding of 0.733N (SD=0.029) and this calibration factor was deducted from all measurements in order to isolate the resistance to sliding of the archwire/bracket/ligature system.

When each of the bracket types was analyzed individually, the ANOVA confirmed that an increase in tip (bracket angulation) produces a significant change in the resistance to sliding (P<0.001) as shown in FIG. 9 where the data for the four bracket types are combined. Above two degrees of tip, the resistance to sliding increases much more dramatically than below two degrees.

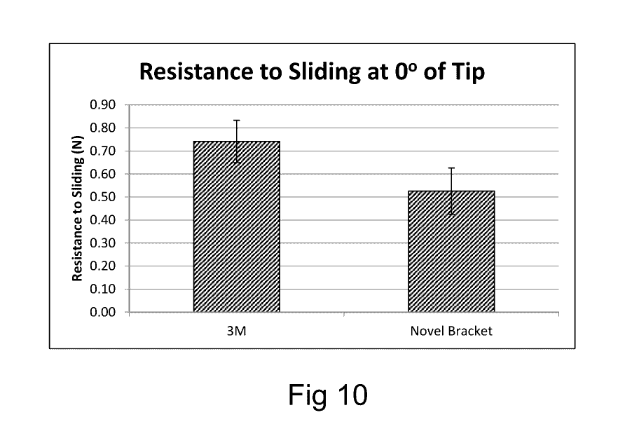

At 0° of tip, the average amount of resistance to sliding was 0.57N (SD, 0.22N). One-way ANOVA analysis showed a significant difference between the different bracket types. For example, the bracket of the invention (“Novel Bracket”), at 0.53N had significantly less resistance to sliding than the 3M bracket which had 0.74N of resistance (see FIG. 10).

The Damon brackets consistently showed a higher standard deviation (1.23N vs. 0.53N) than the other brackets at each of the angles of tip measured.

1. An orthodontic device comprising:
a baseplate having a top surface and a bottom surface;
two at least approximately rectilinear elongated channel wall members having a width, W, a height, H, and a depth, D,
wherein one face of each of said members, defined by dimensions W and D (face WD) is attached to the top surface of the baseplate; and
wherein said members are each attached to said baseplate such that a separate face of each of the two members, defined by the dimensions W and D (face WD), face one another and are at least approximately parallel and spaced apart by a distance, M, so as to form a channel therebetween,
said channel being defined by a portion of the top surface of said baseplate and by the two faces defined by the dimensions H and D of said elongated members (face HD), such that said channel has a volume approximately equal to D×H×M and such that the channel has a first end and a second end and a top, each of which is not enclosed; and
four at least approximately cylindrical rollers, each having a longitudinal axis through the center point of the two at least approximately circular faces of said cylindrical rollers;
wherein each of said cylindrical rollers is positioned at least partially within said channel and each is placed such that its longitudinal axis is at least approximately perpendicular to said top face of said baseplate; and
wherein two of said cylindrical rollers are each positioned partially within first and second recesses in said face HD of one of said channel wall members, the first said recess approximate at the first end of said channel and the other recess approximately at the second end of said channel; and
wherein the other two of said cylindrical rollers are each positioned partially within third and fourth recesses in said face HD of the other said channel wall member, the third said recess approximate at the first end of said channel and the fourth recess approximately at the second end of said channel; and
wherein the two said cylindrical rollers approximately at the first end of said channel are separated by a distance, N1, and the other two said cylindrical rollers at the second end of said channel are separated by a distance, N2, where N1 and N2 are each less than said distance M and may be equal or not equal; and
wherein one end of each of said cylindrical rollers is positioned in a respective hole in said baseplate; and
wherein the other end of each of said cylindrical rollers is positioned partially within said recesses in said face HD of said channel wall members; and
wherein said holes and said recesses have dimensions to provide support for said cylindrical rollers to at least approximately maintain the position of said cylindrical rollers while allowing said cylindrical rollers to rotate about their respective longitudinal axes.

2. The orthodontic device of claim 1, wherein said device further comprises an adhesion pad attached to the bottom face of said base plate.

3. The orthodontic device of claim 1, wherein said holes in said baseplate extend from the top surface of the baseplate to the bottom face of the baseplate.

4. The orthodontic device of claim 1, wherein said holes are approximately cylindrical.

5. The orthodontic device of claim 1, wherein said holes are approximately square in cross section.

6. The orthodontic device of claim 1, wherein said recesses are approximately circular in cross section

7. The orthodontic device of claim 1, wherein said recesses are approximately rectangular in cross section.

8. The orthodontic device claim 1, wherein said cylinders are hollow tubes.

9. The orthodontic device of claim 1, wherein said cylinders are solid.

10. The orthodontic device of claim 1, wherein said cylinders are coated with a low friction material.

11. The orthodontic device of claim 10, wherein said low friction material is chosen from the group consisting awl Teflon, parylene, and a fluoropolymer.

12. The orthodontic device of claim 1 wherein said baseplate, elongated members, and cylindrical rollers are composed of metal.

13. The orthodontic device of claim 12 herein said baseplate, elongated members, and cylindrical rollers are independently composed of stainless steel.

14. The orthodontic device of claim 1 wherein said baseplate, elongated members, and cylindrical rollers are independently composed of titanium.

15. The orthodontic device of claim 1 wherein said baseplate, elongated members, and cylindrical rollers are independently composed of ceramic material.

16. The orthodontic device of claim 1 wherein said dimensions L, H, D, M, and N are each less than 5 millimeters.

17. The orthodontic device of claim 1 wherein said dimensions L, H, D, M, and N are each less than 3 millimeters.

18. The orthodontic device of claim 1 wherein said dimensions L, H, D, M, and N are each less than 2 millimeters.

19. The orthodontic device of claim 1 wherein said device further comprises an arch wire retained in said sliding channel.

20. The orthodontic device of claim 19 wherein said arch wire has a circular cross section.

21. The orthodontic device of claim 19 wherein said arch wire has a rectangular cross section.

22. The orthodontic device of claim 19 wherein said arch wire has an oval cross section.

23. An orthodontic device comprising a metal bracket comprising at least one cylindrical roller at least partially defining a sliding channel for an arch wire, wherein said cylindrical roller is retained in position by said metal bracket and is free to rotate about its longitudinal axis.

24. The orthodontic device claim 23, wherein said orthodontic device further comprises an adhesion pad attached to the bottom face of said bracket.

25. The orthodontic device claim 23, wherein said cylinders are hollow tubes.

26. The orthodontic device of claim 23, wherein said cylinders are solid.

27. The orthodontic device of claim 23, wherein said cylinders are coated with a low friction material.

28. The orthodontic device of claim 27, wherein said low friction material is chosen from the group consisting awl Teflon, parylene, and a fluoropolymer.

29. The orthodontic device of claim 23 wherein said device further comprises an arch wire retained in said bracket.

30. The orthodontic device of claim 29 wherein said arch wire has a circular cross section.

31. The orthodontic device of claim 29 wherein said arch wire has a rectangular cross section.

32. The orthodontic device of claim 29 wherein said arch wire has an oval cross section.

33. A method for adjusting the position of teeth in a person, the method comprising:
attaching one or more orthodontic devices to one or more teeth of the person, said orthodontic device comprising:
a baseplate having a top surface and a bottom surface;
two at least approximately rectilinear elongated channel wall members having a width, W, a height, H, and a depth, D,
wherein one face of each of said members, defined by dimensions W and D (face WD) is attached to the top surface of the baseplate; and
wherein said members are each attached to said baseplate such that a separate face of each of the two members, defined by the dimensions W and D (face WD), face one another and are at least approximately parallel and spaced apart by a distance, M, so as to form a channel therebetween,
said channel being defined by a portion of the top surface of said baseplate and by the two faces defined by the dimensions H and D of said elongated members (face HD), such that said channel has a volume approximately equal to D×H×M and such that the channel has a first end and a second end and a top, each of which is not enclosed; and
four at least approximately cylindrical rollers, each having a longitudinal axis through the center point of the two at least approximately circular faces of said cylindrical rollers;
wherein each of said cylindrical rollers is positioned at least partially within said channel and each is placed such that its longitudinal axis is at least approximately perpendicular to said top face of said baseplate; and
wherein two of said cylindrical rollers are each positioned partially within first and second recesses in said face HD of one of said channel wall members, the first said recess approximate at the first end of said channel and the other recess approximately at the second end of said channel; and
wherein the other two of said cylindrical rollers are each positioned partially within third and fourth recesses in said face HD of the other said channel wall member, the third said recess approximate at the first end of said channel and the fourth recess approximately at the second end of said channel; and
wherein the two said cylindrical rollers approximately at the first end of said channel are separated by a distance, N1, and the other two said cylindrical rollers at the second end of said channel are separated by a distance, N2, where N1 and N2 are each less than said distance M and may be equal or not equal; and
wherein one end of each of said cylindrical rollers is positioned in a respective hole in said baseplate; and
wherein the other end of each of said cylindrical rollers is positioned partially within said recesses in said face HD of said channel wall members; and
wherein said holes and said recesses have dimensions to provide support for said cylindrical rollers to at least approximately maintain the position of said cylindrical rollers while allowing said cylindrical rollers to rotate about their respective longitudinal axes, and
affixing an arch wire to said one or more orthodontic devices within said channel of each orthodontic device such that said orthodontic devices attached to said teeth are able to slide longitudinally along said arch wire.

34-54. (canceled)

55. A method for adjusting the position of teeth in a person, the method comprising:
attaching one or more orthodontic devices to one or more teeth of the person, said orthodontic device comprising:
a metal bracket comprising at least one cylindrical roller at least partially defining a sliding channel for an arch wire, wherein said cylindrical roller is retained in position by said metal bracket and is free to rotate about its longitudinal axis, and
affixing an arch wire to said one or more orthodontic devices such that said orthodontic devices attached to said teeth are able to slide longitudinally along said arch wire.

56-63. (canceled)
